(19) United States
(12) Patent Application Publication
(10) Pub. No.: US 2014/0368787 A1
(43) Pub. Date: Dec. 18, 2014

(54) EYEWEAR CONFIGURED TO SUPPORT COMPUTING DEVICE(S)

(71) Applicant: Marchon Eyewear, Inc., Melville, NY (US)

(72) Inventors: Claudio Gottardi, Pinebrook, NJ (US); Leslie Muller, Woodbury, NY (US); Lucy Wang, New Brunswick, NJ (US); Jane Tsoi, Edgewater, NJ (US); Massimo Baldissarutti, Puos D'Alpago (BL) (IT)

(21) Appl. No.: 14/306,128

(22) Filed: Jun. 16, 2014

Related U.S. Application Data
(60) Provisional application No. 61/835,494, filed on Jun. 14, 2013.
(60) Provisional application No. 61/878,962, filed on Sep. 17, 2013.

(51) Int. Cl. G02C 5/14; G02B 27/01; G02C 11/00; G02C 5/20; G02C 9/00

(52) U.S. Cl. CPC G02C 5/143; G02C 5/20; G02C 9/00; G02C 11/10; G02B 27/0176
USPC 351/158

(57) ABSTRACT

Eyewear in various embodiments comprises a frame configured to support one or more lenses where the frame has a first end, a second end and a top surface extending between the first and second ends. A first temple portion extends rearward from the frame adjacent the frame first end and has a first earpiece extending from the first temple portion. A second temple portion comprises (1) a computing device support arm extending parallel to the first temple portion adjacent the frame second end and (2) a computing device support arm mount coupled at least partially along at least a portion of the top surface adjacent the frame second end and configured to support a computing device either releasably coupled, or permanently attached, to the computing device support arm so a display of the computing device is positioned substantially in the upper portion of one of the one or more lenses.

### CROSS-REFERENCE TO RELATED APPLICATIONS

This patent application claims priority from: (1) U.S. Provisional Patent Application 61/835,494, entitled “Eyewear Configured to Support Computing Device(s)”, which was filed on Jun. 14, 2013; and (2) U.S. Provisional Patent Application 61/878,962, entitled “Eyewear Configured to Support Computing Device(s)”, which was filed on Sep. 17, 2013, both of which are hereby incorporated herein by reference in their entirety.

### BACKGROUND

Users desire convenient ways to access their computing devices. Accordingly, there is a need for improved systems for enabling users to access computing devices easily and on the go.

### SUMMARY

Eyewear in various embodiments comprises a frame configured to support one or more lenses where the frame has a first end, a second end, and a top surface extending between the first and second ends. A first temple portion extends substantially rearward from the frame adjacent the frame first end and has a first earpiece extending from the first temple portion. A second temple portion comprises (1) a computing device support arm that extends substantially parallel to the first temple portion adjacent the frame second end, and (2) a computing device support arm mount that is coupled at least partially along at least a portion of the top surface adjacent the frame second end and configured to support a computing device that is either releasably coupled, or permanently attached, to the computing device support arm.

In various embodiments, the computing device support arm mount is configured to position a display of a computing device that is being supported by the computing device support arm in line with, and spaced apart from, an upper portion of one of the one or more lenses. In some embodiments, when the computing device is supported by the computing device support arm, the first earpiece, at least a portion of the frame, and at least a portion of the computing device are configured to cooperate to maintain the eyewear adjacent a wearer's head. In various embodiments, when the computing device is supported by the computing device support arm and the eyewear is adjacent the wearer's head, the display associated with the computing device is disposed at least partially in front of one of the one or more lenses and the wearer is able to view the display by looking through the one of the one or more lenses.

In various embodiments, the first temple portion defines a second top surface that together with the frame top surface define a substantially continuous top surface. In some of these embodiments, the computing device support mount is disposed above the substantially continuous top surface. In various embodiments, one of a computing device mounting portion and the computing device support arm further comprises a tongue and the other of the computing device mounting portion and the computing device support arm contains a groove that cooperate with one another to allow the computing device to be releasably attached to the frame.

In yet another embodiment, eyewear comprises a frame that is configured to support one or more lenses where the frame has a first end, a second end, and a top surface that extends between the first and second ends. A first temple portion extends substantially rearward from the frame first end. A temple support mount couples to the eyewear frame top surface adjacent to the frame second end and is configured to support a second temple portion. The temple support mount is configured to position the second temple portion higher than the first temple portion with respect to the frame top surface. Furthermore, the second temple portion is configured to couple to a computing device that has a display so that the computing device display is disposed in line with and spaced apart from an upper portion of one of the one or more lenses.

In still another embodiment, eyewear comprises a frame that is configured to support one or more lenses where the frame has a first end, a second end, and a top surface extending between the first and second ends. A first temple portion extends substantially rearward from the frame adjacent the frame first end, and a second temple portion extends substantially rearward from the frame adjacent the frame second end. A computing device has a first portion that is configured to couple to the second temple portion and a second portion that is offset from the first portion in a direction that is substantially perpendicular to the frame top surface so that a top surface of a display that is coupled to the computing device second portion is disposed substantially coplanar with, and spaced apart from, the top surface of the frame.

### BRIEF DESCRIPTION OF THE DRAWINGS

Various embodiments of eyewear configured to support computing device(s) are described below. In the course of this description, reference will be made to the accompanying drawings, which are not necessarily drawn to scale, and wherein:

FIG. 1 is a front right perspective view of eyewear having a computer attached thereto in accordance with a first embodiment;

FIG. 2 is a top left perspective view of the eyewear of FIG. 1;

FIG. 3 is a front plan view of the eyewear shown in FIG. 1;

FIG. 4 is a front right perspective view of eyewear having a computer attached thereto in accordance with a second embodiment;

FIG. 5 is a front left perspective view of the eyewear of FIG. 4;

FIG. 6 is a front plan view of the eyewear shown in FIG. 4;

FIG. 7 is a sketch of eyewear and a display in relation to a wearer's eye;

FIG. 8 is a schematic drawing of eyewear and a display in relation to a wearer's eyes;

FIG. 9 depicts eyewear according to yet another embodiment; and

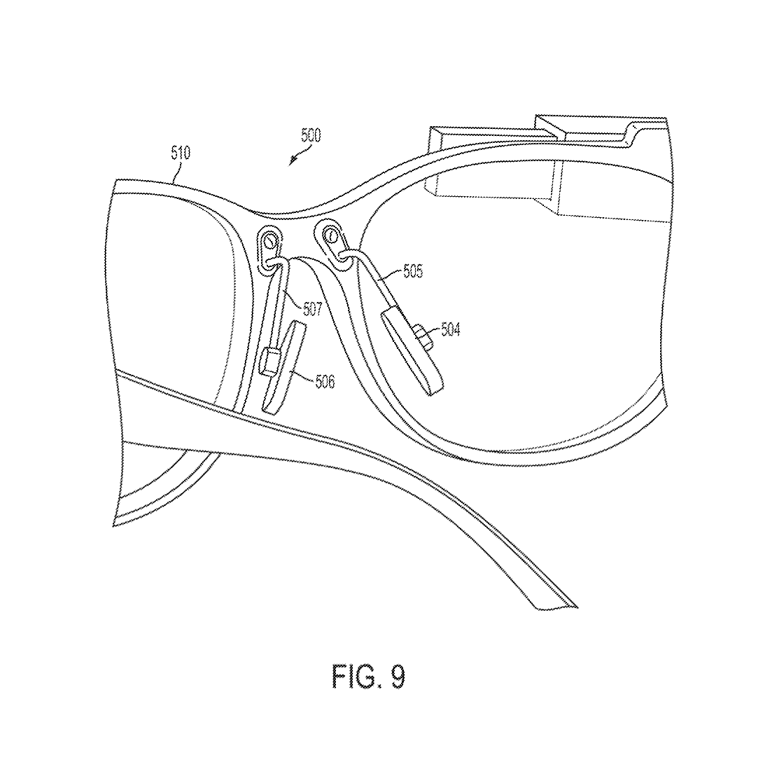

FIG. 10 depicts exemplary system architecture for an example computing device.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Eyewear

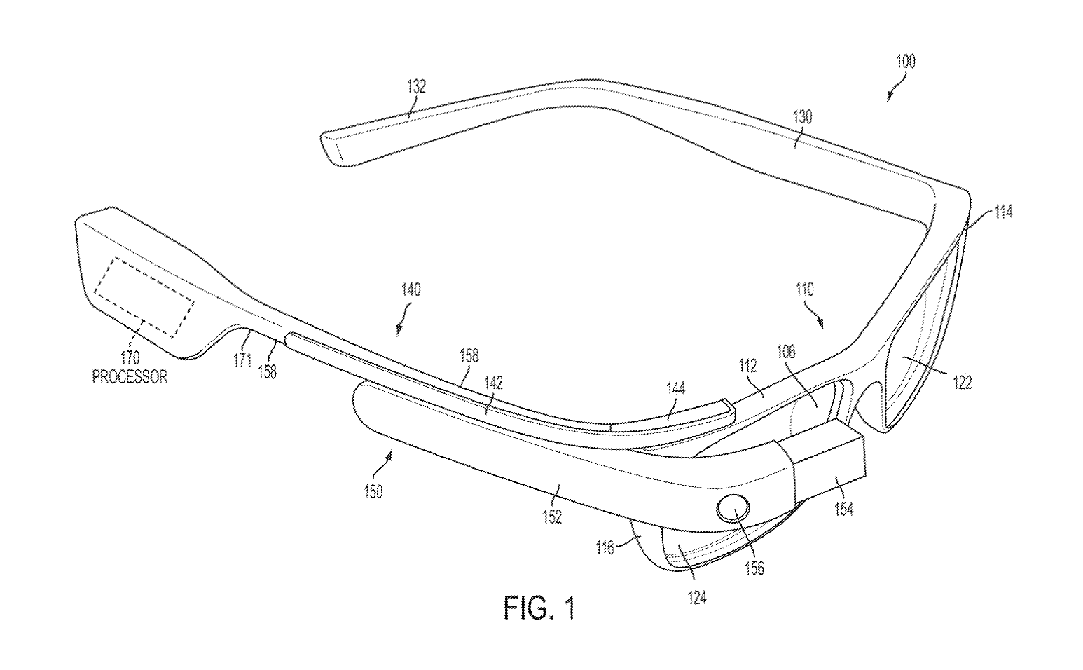

As shown in FIG. 1, eyewear 100, according to various embodiments, includes: (1) an eyeglass frame 110; (2) a first temple portion 130; (3) a second temple portion 140; and (4) one or more computing devices 150. These various components are discussed in more detail below.

Eyeglass Frame

Eyewear, in various embodiments, includes any suitable eyeglass frame 110 configured to support one or more lenses 122, 124. In the embodiment shown in this figure, the eyeglass frame 110 has a first end 114 and a second end 116 and a top surface 112 that extends between the first end second ends. In particular embodiments, the eyewear frame 110 is configured to support the first and second lenses 122, 124 about the full perimeter of the first and second lenses 122, 124. In other embodiments, the eyeglass frame 110 may be configured to support the first and second lenses 122, 124 about only a portion of each respective lens. In various embodiments, the eyeglass frame 110 is configured to support a number of lenses other than two lenses (e.g., a single lens, a plurality of lenses, etc.). In particular embodiments, the lenses 122, 124 may include prescription lenses, sunglass lenses, or any other suitable type of lens (e.g., reading lenses, non-prescription lenses, bifocal lenses, 3D lenses, etc.).

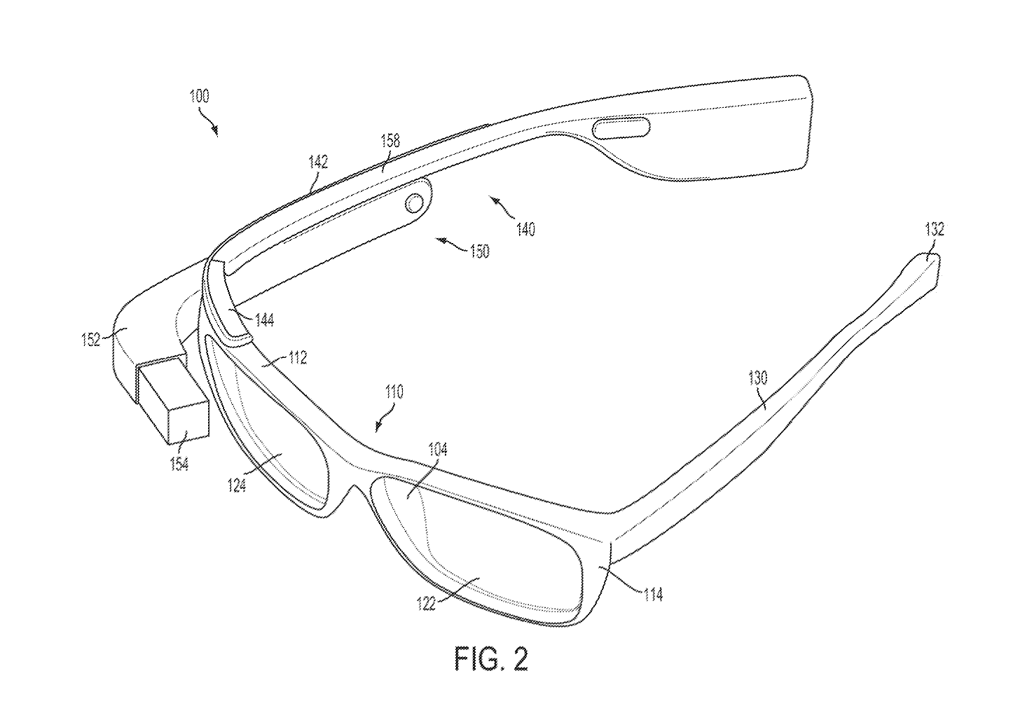

In the embodiment shown in FIGS. 1 and 2, the eyeglass frame 110 includes a first and second nose pad 104, 106, which may be configured to maintain the eyewear 100 adjacent the front of a wearer's face such that the lenses 122, 124 are positioned substantially in front of the wearer's eyes while the wearer is wearing the eyewear 100. In particular embodiments, the nose pads 104, 106 may comprise a material that is configured to be comfortable when worn by the wearer (e.g., rubber, etc.). In other embodiments, the nose pads 104, 106 may include any other suitable material (e.g., plastic, metal, etc.).

First Temple Portion

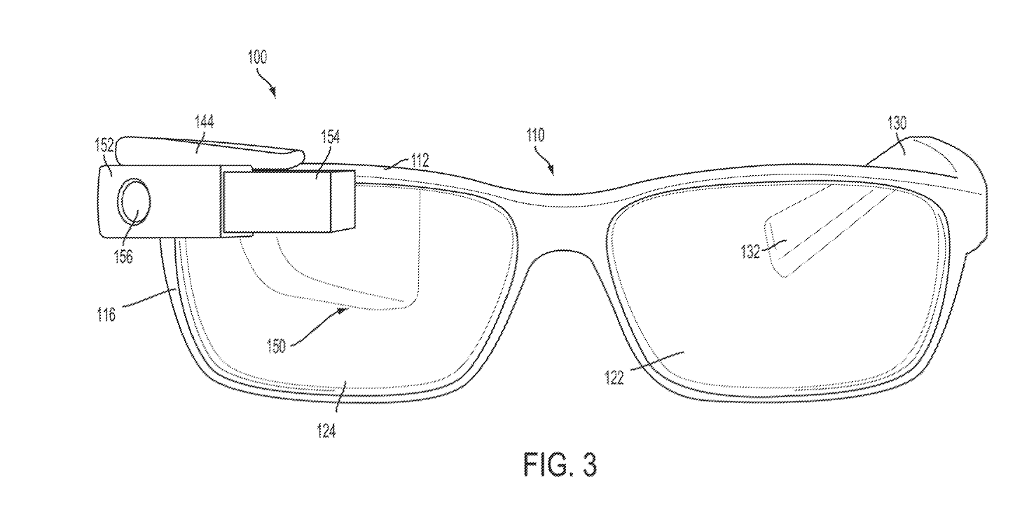

As shown in FIGS. 1-3, the first temple portion 130, according to various embodiments, extends substantially rearward from the eyeglass frame 110 adjacent a first side 114 of the eyeglass frame 110. As shown in these figures, the first temple portion 130 includes an earpiece 132 configured to be supported by a wearer's ear.

Second Temple Portion

The second temple portion 140 extends substantially rearward from the eyeglass frame 110 adjacent a second side 116 of the eyeglass frame 110. In the embodiment shown in the FIGS. 1-3, the second temple portion 140 includes a computing device support arm 142 that is coupled to the eyewear frame 110 by a computing device support arm mount 144. In particular embodiments, the computing device support arm mount 144 is disposed along at least a portion of a top surface 112 of the eyeglass frame 110 adjacent the eyewear second side 116. In various embodiments, the eyewear frame 110 and the computing device support arm mount 144 may form a substantially continuous, single piece of material (e.g., may be integrally formed). In other embodiments, the computing device support arm mount 144 and the eyewear frame 110 may include one or more pieces of material, which are attached in any suitable manner (e.g., via any suitable adhesive, via screws or other suitable fasteners, etc.).

In particular embodiments, the computing device support arm mount 144 may extend at least substantially perpendicularly from the eyewear frame's top surface 112 so as to support the computing device support arm 142 above the eyewear frame's top surface 112. In other embodiments, the computing device support arm mount 144 may extend substantially upward from an upper portion of the eyewear frame 110 in any other suitable manner such that at least a portion (e.g., the computing device support arm 142) of the second temple portion 140 is above the eyewear frame's top surface 112.

In the embodiment shown in FIG. 1, the computing device support arm 142 is substantially parallel to the first temple portion 130, and the computer device support arm 142 is disposed in a position that is higher than the first temple portion 130. In particular embodiments, the computing device support arm 142 is configured to support one or more computing devices 150 (an exemplary computing device 150 is described more fully below). That is, the computer device support arm 142 is sized, shaped, and positioned with respect to the eyewear frame 110 such that a display 154 associated with the supported computing device 150 is located in a suitable position for viewing by a wearer of the eyewear 100.

Computing Device

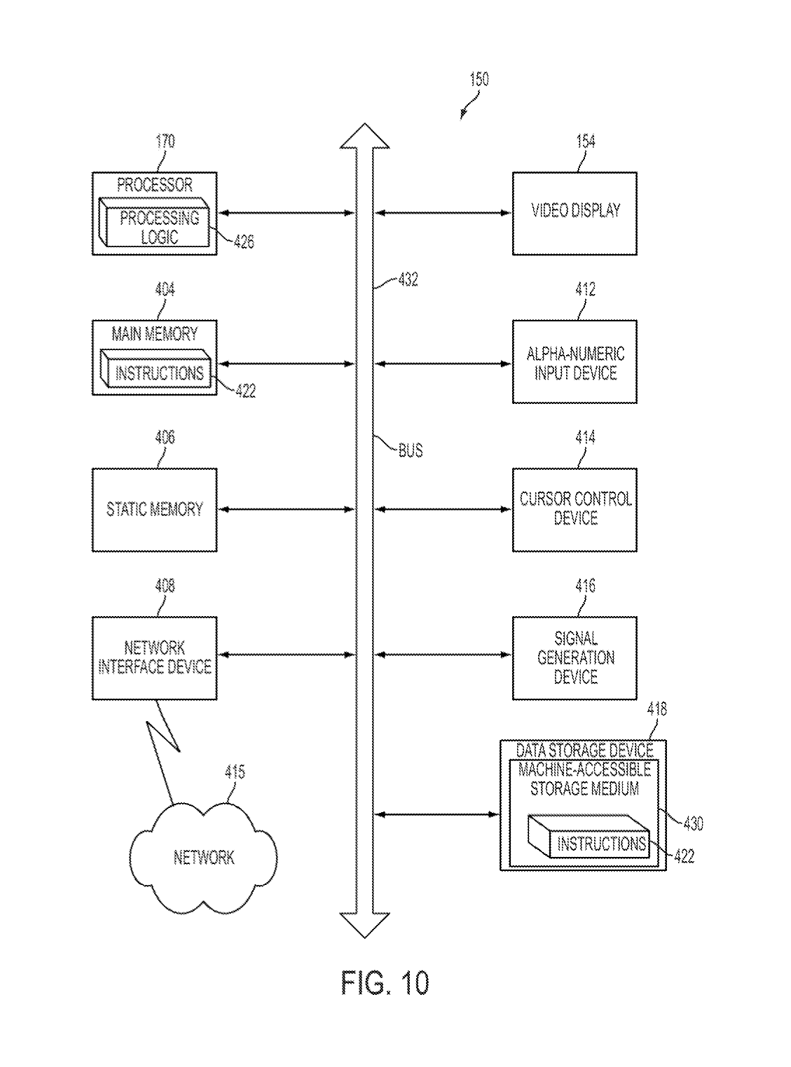

Referring once again to FIGS. 1-3, in various embodiments, the computing device 150 comprises: (1) one or more processors 170; (2) a display support 152; (3) one or more displays 154 having a lower portion 153 and an upper portion 155 (FIG. 10); (4) one or more cameras 156; (5) a computing device mounting portion 158; and (6) a computing device ear support portion 171 for supporting the computing device 150 on the user's ear. A discussion of an exemplary architecture for the computing device 150 is provided below.

Display

Referring particularly to FIG. 1, the display support 152 is configured to maintain the display 154 in a location suitable for viewing by the wearer of the eyewear 100 while the computing device 150 is supported by the computing device support arm 142. The display 154 is positioned such that the display 154 is in line with and spaced apart from an upper portion of one of the lenses 122, 124. It should be noted that the display may be mounted to either temple depending on the design of the eyewear. In this configuration, the display 154 is disposed in a location that enables a wearer of the eyewear 100 to at least partially view the display 154 while the wearer is wearing the eyewear 100. In the embodiment shown in FIGS. 1-3 and in other embodiments, the display 154 is positioned such that a wearer of the eyewear 100 may view the display 154 without causing substantial blockage of the user's sight and strain on the wearer's eyes (e.g., because the display 154 is disposed within the wearer's field of vision such that the display 154 is visible to the wearer). In still other embodiments, a top surface of the display is substantially coplanar with the top surface of the frame 112 and spaced apart from the frame top surface 112 and the lens 124. In various embodiments, the display 154 is disposed sufficiently out of (e.g., in a location above) the wearer's field of vision such that the display 154 does not substantially interfere with the wearer's field of vision. In such embodiments, the wearer may need to look up (e.g., or in a direction in which the display is positioned relative to the wearer's field of vision) in order to at least partially view the display 154.

In other embodiments, such as embodiments in which the computing device support arm 142 is substantially aligned with the eyewear frame's top surface 112, the computing device 150 may be sized and shaped such that the display 154 is disposed in a position suitable for viewing by the wearer (e.g., the display 154 is in a position similar to the position that results when the computing device support arm 142 is offset from the top surface 112). The display support 152 may, for example, be at least partially curved to raise the display 154 to a suitable position, or have any other suitable configuration for achieving a suitable position of the display 154.

In particular embodiments, the one or more lenses 122, 124 may comprise at least a portion of the display 154. In other embodiments, the one or more lenses 122, 124 may comprise the display 154 (e.g., the display is integrated into one or both of the lenses 122, 124).

Camera

In various embodiments, the computing device 150 includes one or more cameras 156. The one or more cameras 156 may be configured to enable the wearer of the eyewear 100 to capture one or more images (e.g., video images, still images, etc.), for example, using the computing device 150. In other embodiments, where the display is in the direct line of sight of the user, the one or more cameras 156 may capture the image that the user would see if the display 154 were not present and display the image on the display 154. This may allow users to view their surroundings without having to move the display out of their line of sight (e.g., the user's right eye views their surroundings on the display 154 while their left eye views their surroundings directly with their eye).

Computing Device Mounting Portion

In various embodiments, the computing device mounting portion 158 is configured to cooperate with the computing device mounting arm 142 to maintain the computing device 150 adjacent the eyewear 100. In particular embodiments, the computing device mounting portion 158 may include any suitable attachment mechanism (e.g., such as an attachment mechanism that is configured to cooperate with a corresponding attachment mechanism of the computing device mounting arm 142). Suitable attachment mechanisms may include a tongue formed on one of the computing device mounting arm 142 and the computing device 150, and a groove formed in the other of the computing device mounting arm 142 and the computing device 150 so that the groove receives the tongue thereby coupling the parts. In other embodiments, the computing device 150 may be coupled to the computing device mounting arm 142 by one or more suitable fasteners (e.g., screws, rivets, etc.).

Relationship Between Display and User's Eye

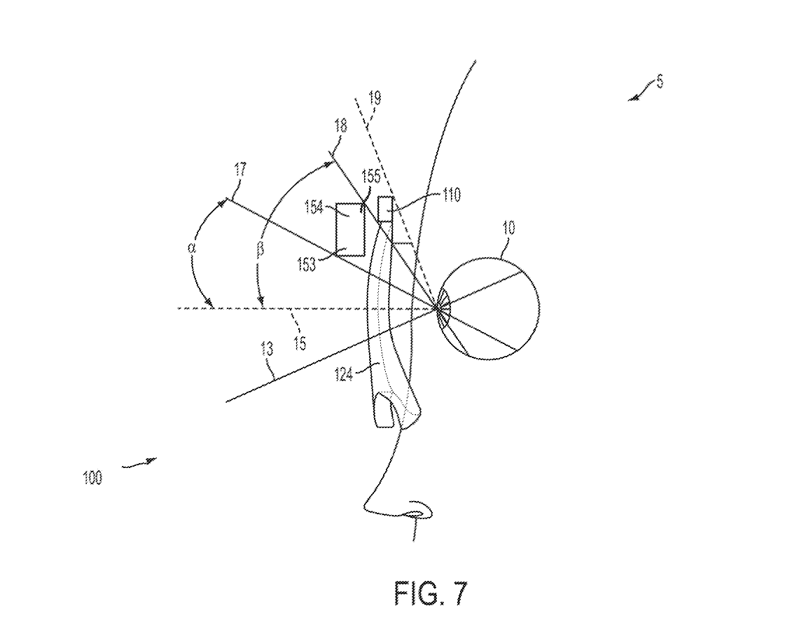

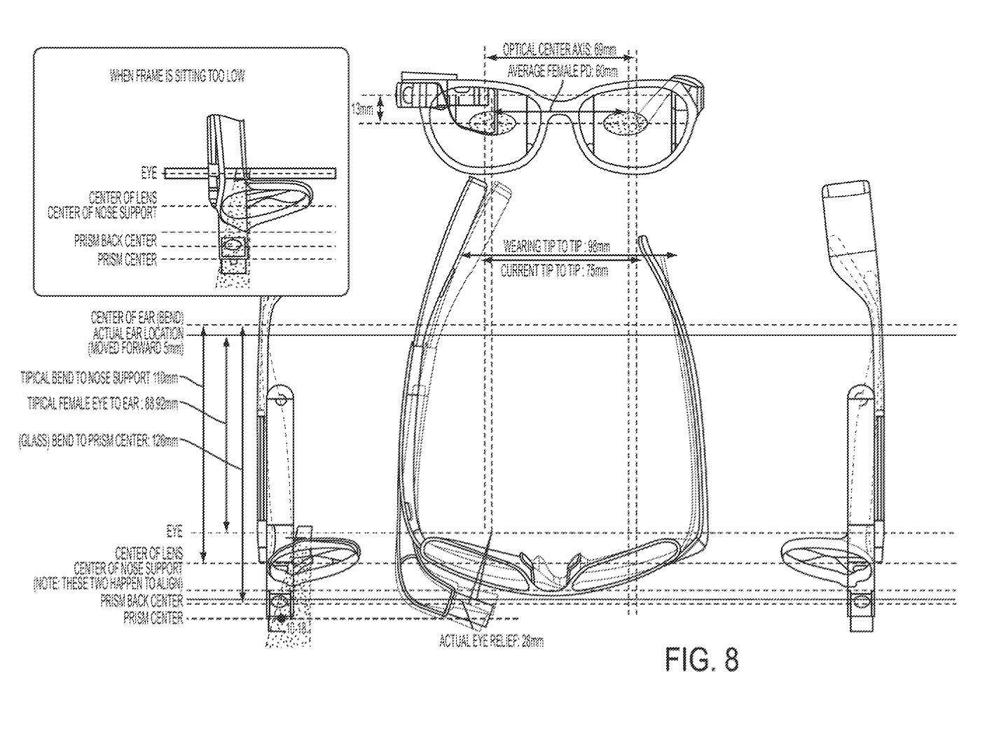

FIGS. 7 and 8 depict the spatial relationship between the display 154 and an eye 10 of a user 5 of the eyewear 100. In particular, FIG. 10 depicts a side view of the user's face while wearing the eyewear 100 with lines of sight that generally indicate the user's vertical field of vision (e.g., the range within which a user may direct their line of sight between an upper and lower bound). In various embodiments, a user's field of vision may include everything (e.g., at a given time) that causes light to fall onto the user's retina. The user has a neutral line of sight 15 which may, for example, include the user's line of sight when the user's face is substantially upright (e.g., upright), and the user 5 is looking substantially directly ahead (e.g., directly ahead). An upper line of sight 19 and a lower line of sight 13 depict a representative field of vision within which the user 5 may direct their eye 10 while their head is at least substantially stationary. As may be understood from the Figure, when the user 5 is wearing the eyewear 100, the display 154 is positioned in an upper portion of the lens 124 (e.g., between the upper line of sight 19 and a first line of sight 17).

It should be understood by reference to the figure that the user's field of vision through a eyewear frame various based on several factors that include, but are not limited to: (1) the size of the lens opening; (2) the distance that the frame is positioned from the user's eye; (3) the height of the lens from top to bottom; and (4) where the frame sits on the user's face (e.g., does the frame ride high or low on the nose). In particular embodiments, the user's field of vision may extend to approximately 85 degrees above the neutral line of sight 15 (e.g., an angle between the user's upper line of sight 19 and neutral line of sight 15 may be about 85 degrees) and about 85 degrees below the neutral line of sight 15 (e.g., an angle between the user's lower line of sight 13 and neutral line of sight 15 may be about 85 degrees). In a particular embodiment, the eyewear 100 is configured such that the display 154 is positioned substantially in line with the user's neutral line of sight 15 (e.g., the user's line of sight when the user is looking substantially straight ahead from an upright position). In other embodiments, the display 154 is positioned substantially between the user's neutral line of sight 15 and the user's upper line of sight 19.

In various embodiments, a lower portion 153 of the display 154 is substantially in line with the first line of sight 17 that is between the neutral line of sight 15 and the upper line of sight 19. In particular embodiments, the first line of sight 17 is angled such that the lower portion 153 of the display 154 does not substantially interfere with (e.g., or distract) the user's vision (e.g., line of sight) while the user 5 is wearing the eyewear but not looking at the display 154 (e.g., is looking substantially forward or looking around at their environment). In various embodiments, when the user 5 is looking in a direction that is substantially in line with the user's neutral line of sight 15, the eyewear 100 is configured such that the display 154 does not substantially distract the user 5 by at least partially obstructing the user's field of vision. In particular, as may be understood from FIG. 7, the display 154 is disposed sufficiently close to the eyewear frame 110 such that the first line of sight 17 with respect to the lower portion 153 of the display is sufficiently high so as not to substantially interfere with the user's field of vision when the user 5 is looking substantially toward the neutral line of sight 15.

In particular embodiments, the upper portion 155 of the display 154 is positioned substantially in line with a second line of sight 18 that is between the neutral line of sight 15 and the upper line of sight 19 while the user 5 is wearing the eyewear 100. The second line of sight 18 extends from the user's eye 10 through the lens 124 to the display's upper portion 155. In the embodiment shown in this figure, the second line of sight 18 to the display's upper portion 155 is substantially free of obstruction by the eyeglass frame 110 (e.g., the eyeglass frame 110 does not substantially block the user's view of the display's upper portion 155). In particular embodiments, the user's substantially unobstructed view of the display's upper portion 155 may be achieved based at least in part on the distance from which the display 154 is spaced apart from the eyeglass frame 110. That is, the closer the display 154 is to the frame 110, the lower the display 154 must be positioned relative to the frame 110 to remain substantially unobstructed. Thus, it should be understood that the maximum height of the display 154 relative to the eyeglass frame 110 is a function of the distance the display 154 is positioned from the front of the eyeglass frame 110.

In particular embodiments, the display 154 is spaced apart from the eyeglass frame 110 a sufficient distance such that the second line of sight 18 to the display's upper portion 155 is not obstructed by the eyeglass frame 110. Moreover, the position of the display's lower portion 153 with respect to the first line of sight 17 is such that an angle α between the neutral line of sight 15 and the first line of sight 17 is sufficiently large so that the display 154 does not substantially interfere with the user's vision through the lens 124 when the user is looking substantially along the neutral line of sight 15. In particular embodiments, the angle α formed between the neutral line of sight 15 and the first line of sight 17 to the display's lower portion 153 is between about 10 degrees and about 18 degrees. In other embodiments, the angle α is between about 15 degrees and about 45 degrees. In a particular embodiment, the angle α is about 20 degrees. Once again, it should be noted that the angle α will depend on the size of the frame, the position of the frame on the wearer's face (e.g., riding high or low on the nose) and the height of the lens.

In various embodiments, an angle β formed between the neutral line of sight 15 and the second line of sight 18 to the display's upper portion 155 is between about 15 degrees and about 85 degrees. In a particular embodiment, the angle β is about 60 degrees. In still other particular embodiments, the angle β is about 30 degrees. In various embodiments, the second line of sight 18 to the display's upper portion 155 is equal to the user's upper line of sight 19.

### Exemplary Use

Referring again to FIGS. 1-3, in various embodiments, when the computing device 150 is supported by the computing device support arm 142, the earpiece 132, the nose pads 104, 106, and the computing device ear portion 171 are configured to cooperate to maintain the eyewear 100 adjacent the wearer's head. While wearing the eyewear 100, the wearer may, for example, view content from the computing device 150 by looking through one of the one or more lenses 122, 124 and viewing the display 154. In particular embodiments, by enabling a wearer to view the display 154 through the one or more lenses, 122, 124, the eyewear 100 may enable the wearer to view the display 154 substantially clearly (e.g., because the wearer would be looking at the display through corrective lenses if they require them).

### Alternative Embodiments

### Alternative Frame Design

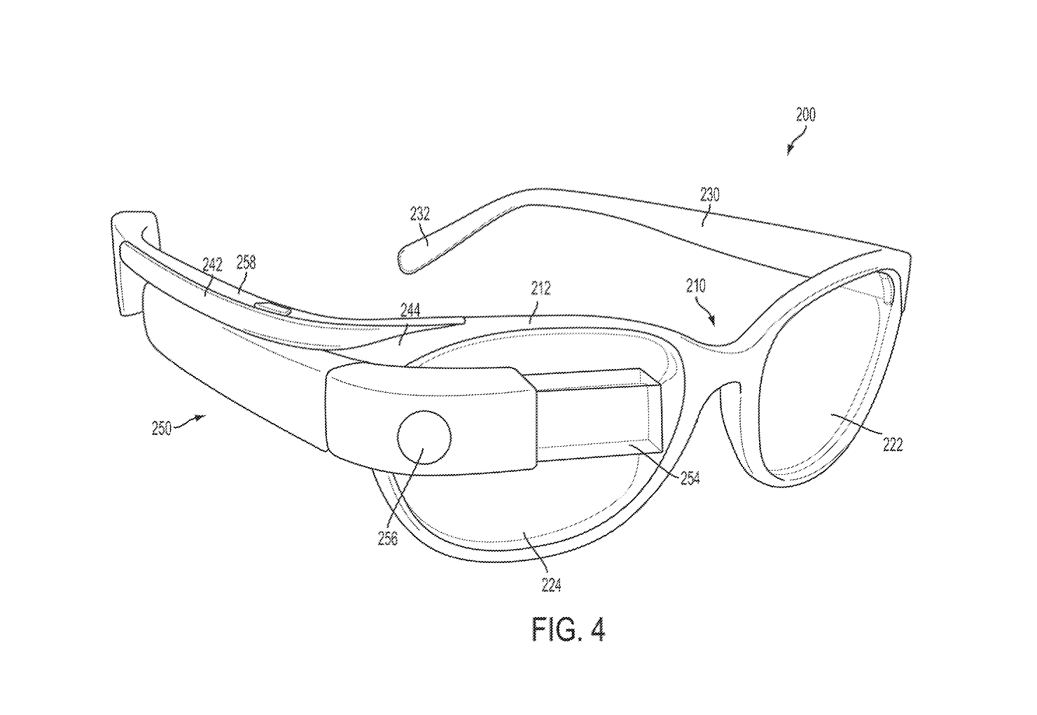

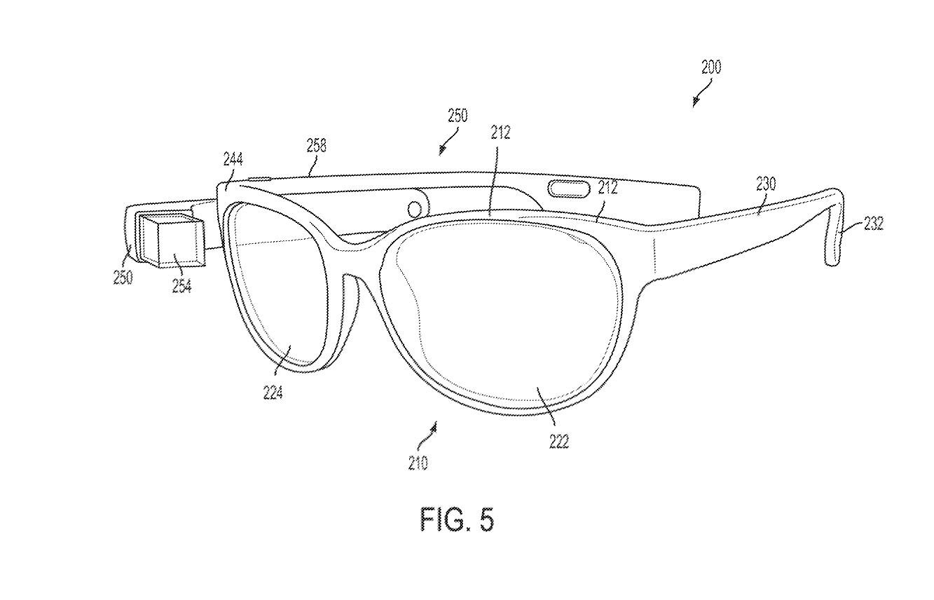

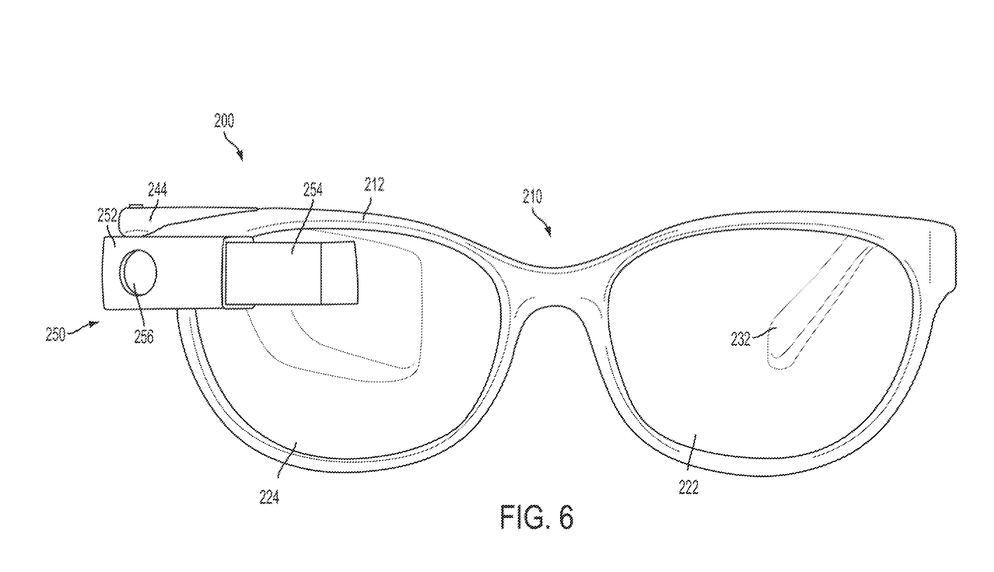

FIGS. 4-6 show eyewear 200 comprising a computing device 250 coupled to an eyewear frame 210 having cat-eye shaped lenses 222, 224. The eyewear frame 210 in these figures differs from the eyewear frame 110 shown in FIGS. 1-3 in that the top surface 212 of the eyewear frame 210 is curved. In this embodiment, a computing device supporting arm mount 244 extends up and out from the curved top surface 212. In this configuration, the computing device mounting arm 242 is positioned higher than a first temple portion 230.

Computing Device Support Mechanism

Referring once again to FIGS. 1-3, in still other embodiments, the second temple portion 140 may extend substantially rearward from the eyeglass frame 110 adjacent the second side 116 of the eyeglass frame 110. In these embodiments, the second temple portion 140 includes a computing device support arm 142 that is coupled to the second temple portion 140 and that extends upward perpendicular to a top surface of the second temple portion 140 such that the computing device support arm is positioned higher up than the first temple and the second temple with respect to the frame top surface 112.

In the embodiment shown in FIG. 1, the computing device support arm 142 is substantially parallel to the first and second temple portions 130, 140 and the computer device support arm 142 is disposed in a position that is higher than the first and second temple portions 130, 140. In particular embodiments, the computing device support arm 142 is configured to support one or more computing devices 150 (an exemplary computing device 150 is described more fully below). That is, the computer device support arm 142 is sized, shaped, and positioned with respect to the eyewear frame 110 such that a display 154 associated with the supported computing device 150 is located in a suitable position for viewing by a wearer of the eyewear 100.

In yet other embodiments, the eyewear 100 may be configured to support the computing device 150 using any other suitable portion of the eyewear 100 (e.g., a portion of the eyewear 100 other than the computing device support arm 142. In particular embodiments, any suitable combination of elements of the eyewear 100 may cooperate to support the computing device 150 (e.g., the display 154 may be integrally formed with the frame 110).

Voice Control of Computing Device

In various embodiments, the computing device 150 may comprise one or more microphones (not shown) and be configured to receive instructions and commands via a user's voice (e.g., using any suitable voice-recognition techniques).

### Exemplary Computing Device Architecture

FIG. 13 illustrates a diagrammatic representation of a computer architecture that can be used within eyewear with a computing device system, for example, as a computing device. In particular embodiments, the computing device 150 may be connected (e.g., networked) to other computers in a LAN, an intranet, an extranet, the Internet, wirelessly (e.g., via WIFI), via Bluetooth, etc. As noted above, the computing device 150 may operate in the capacity of a server or a client computer in a client-server network environment, or as a peer computer in a peer-to-peer (or distributed) network environment. The computing device 150 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computing device 150 includes a processing device 170, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 432.

The processing device 170 represents one or more general-purpose processing devices such as a microprocessor, a central processing unit, or the like. More particularly, the processing device 170 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 170 may also be one or more special-purpose processing devices such as an application specific integrated circuit (ASIC), a field programmable gate array (FPGA), a digital signal processor (DSP), network processor, or the like. The processing device 170 may be configured to execute processing logic 426 for performing various operations and steps discussed herein.

The computing device 150 may further include a network interface device 408. The computing device 150 also may include the video display unit 154 (e.g., a liquid crystal display (LCD), a plasma display, a Light Emitting Diode display (LED), a cathode ray tube (CRT), or any other suitable display that can supported by an eyewear frame), an alphanumeric input device 412 (e.g., a Bluetooth keyboard), a voice-control module (not shown), a cursor control device 414 (e.g., a Bluetooth mouse), and a signal generation device 416 (e.g., a speaker).

The data storage device 418 may include a non-transitory computer-accessible storage medium 430 (also known as a non-transitory computer-readable storage medium or a non-transitory computer-readable medium) on which is stored one or more sets of instructions (e.g., software 422) that the processing device 170 may be configured to perform. The software 422 may also reside, completely or at least partially, within the main memory 404 and/or within the processing device 170 during execution thereof by the computing device 150—the main memory 404 and the processing device 170 also constituting computer-accessible storage media. The instructions 422 may further be transmitted or received over a network 415 via the network interface device 408.

While the machine-accessible storage medium 430 is shown in an exemplary embodiment to be a single medium, the term “computer-accessible storage medium” should be understood to include a single medium or multiple media (e.g., a centralized or distributed database, and/or associated caches and servers) that store the one or more sets of instructions 422. The term “computer-accessible storage medium” should also be understood to include any medium that is capable of storing, encoding, or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the eyewear described in this embodiment may include any other suitable eyewear, such as, for example, ski or swim goggles, sunglasses, safety goggles or glasses, etc. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

What is claimed is:

1. Eyewear comprising:
a. a frame configured to support one or more lenses, the frame having a first end and a second end and a top surface extending between the first and second ends;
b. a first temple portion that extends substantially rearward from the frame adjacent the frame first end;
c. a first earpiece extending from the first temple portion; and
d. a second temple portion comprising a computing device support arm that extends substantially parallel to the first temple portion adjacent the second end of the frame and a computing device support arm mount disposed at least partially along at least a portion of the top surface adjacent the second end;
wherein the computing device support arm is configured to support a computing device.

2. The eyewear of claim 1, wherein the computing device support arm mount is configured to position a display of a computing device being supported by the computing device support arm in line with and spaced apart from an upper portion of one of the one or more lenses.

3. The eyewear of claim 1, wherein when the computing device is being supported by the computing device support arm, the first earpiece, at least a portion of the frame, and at least a portion of the computing device are configured to cooperate to maintain the eyewear adjacent a wearer's head.

4. The eyewear of claim 3, wherein:
a. when the computing device is being supported by the computing device support arm, the display associated with the computing device is disposed at least partially in front of one of the one or more lenses; and
b. when the eyewear is adjacent the wearer's head, the eyewear is configured to enable the wearer to view the display by looking through the one of the one or more lenses.

5. The eyewear of claim 1, wherein:
a. the first temple portion defines a second top surface; and
b. the second top surface and the top surface of the eyewear frame define a substantially continuous top surface.

6. The eyewear of claim 5, wherein the computing device support arm mount is disposed above the substantially continuous top surface.

7. The eyewear of claim 1, wherein the computing device comprises a computing device mounting portion configured to cooperate with the computing device support arm to maintain the computing device adjacent the eyewear.

8. The eyewear of claim 1, wherein one of the computing device and the computing device support arm further comprises a tongue and the other of the computing device and the computing device support arm further comprises a groove wherein the groove is configured to operatively receive the tongue.

9. The eyewear of claim 1, wherein the computing device and the computing device support arm are releasably coupled by a fastener.

10. The eyewear of claim 1, wherein the computing device is configured to enable a user to selectively attach the computing device to the eyewear substantially without the use of tools.

11. The eyewear of claim 1, further comprising
a. a first frame support comprising an adjustable arm having a first end coupled to the frame and a second end coupled to a first nose pad; and
b. a second frame support comprising an adjustable arm having a first end coupled to the frame and a second end coupled to second nose pad,
wherein said first and second nose pads are configured to cooperate to maintain said frame in a substantially fixed position relative to said wearer's face.

12. The eyewear of claim 11, wherein:
a. said first adjustable arm is configured to enable said wearer to adjust a position of said first nose pad relative to said frame; and
b. said second adjustable arm is configured to enable the wearer to adjust a position of said second nose pad relative to said frame.

13. Eyewear comprising:
a. a frame configured to support one or more lenses, the frame having a first end, a second end and a top surface that extends between the first and second ends;
b. a first temple portion that extends substantially rearward from the frame first end;
c. a second temple portion that extends substantially rearward from the frame second end;
d. a computing device support arm coupled to the second temple portion, wherein the computing device support arm extends upward from the second temple portion, wherein:
i. the computing device support arm is configured to couple to a computing device having a display; and
ii. the computing device support arm is configured to position the display in line with and spaced apart from an upper portion of one of the one or more lenses.

14. The eyewear of claim 13, wherein the computing device support arm is configured to releasably connect to the computing device.

15. The eyewear of claim 13, wherein a top surface of the display is substantially coplanar with at least a portion of the frame top surface.

16. The eyewear of claim 13, wherein the computing device support arm is integrally formed with the second temple portion.

17. The eyewear of claim 13, further comprising
a. a first frame support comprising an adjustable arm having a first end coupled to the frame and a second end coupled to a first nose pad; and
b. a second frame support comprising an adjustable arm having a first end coupled to the frame and a second end coupled to second nose pad,
wherein said first and second nose pads are configured to cooperate to maintain said frame in a substantially fixed position relative to said wearer's face.

18. The eyewear of claim 17, wherein:
a. said first adjustable arm is configured to enable said wearer to adjust a position of said first nose pad relative to said frame; and
b. said second adjustable arm is configured to enable the wearer to adjust a position of said second nose pad relative to said frame.

19. Eyewear comprising:
a. an eyewear frame configured to support one or more lenses, said eyewear frame having a first side and a second side and defining a top surface;
b. a first temple portion that extends substantially rearward from said eyeglass frame adjacent said first side of said eyewear frame;
c. a first earpiece extending from said first temple portion; and
d. a second temple portion comprising a computing device support arm that extends substantially parallel to said first temple portion adjacent said second side of said eyewear frame and a computing device support arm mount disposed at least partially along at least a portion of said top surface adjacent said second side;
wherein said computing device support arm is configured to support a computing device comprising a display such that a portion of the display is substantially adjacent said top surface of said frame.

20. The eyewear of claim 19, wherein said display is disposed in front of and spaced apart from said frame top surface when said computing device is being supported by said computing device support arm.

21. The eyewear of claim 20, wherein said display is disposed substantially between a neutral line of sight and an upper line of sight of a user of said eyewear when said user is wearing said eyewear.

22. The eyewear of claim 21, wherein said display is positioned such that said display is configured to not substantially interfere with said user's neutral line of sight.

23. The eyewear of claim 21, wherein a first angle between said neutral line of sight and a first line of sight to a lower portion of said display is between about 10 degrees and about 30 degrees.

24. The eyewear of claim 23, wherein said first angle is about 20 degrees.

25. The eyewear of claim 23, wherein a second angle between said neutral line of sight and a second line of sight to an upper portion of said display is between about 15 degrees and about 85 degrees.

26. The eyewear of claim 25, wherein said second angle is about 25 degrees.

27. Eyewear comprising:
a. a frame comprising:
i. a first side and a second side,
ii. a first opening proximate the first side and a second opening proximate the second side, wherein a centerline of the first and second openings are configured to align with the neutral line of sight of a wearer of the frame; and
iii. a top surface extending between the first and second sides;
b. a first temple portion having a first end that extends substantially rearward from said first side of said frame and a second end having a first earpiece extending therefrom;
c. a second temple portion comprising:
i. a computing device support arm mount coupled to said second side of said frame proximate said second end at least partially along at least a portion of said top surface of said frame, and
ii. a computing device support arm having a first end coupled to said computing device support arm mount and a second end having a second earpiece extending therefrom, wherein the computing device support arm extends rearwardly from said frame and substantially parallel to said first temple portion,
wherein:
i. said computing device support arm is configured to support a computing device having at least one display having a top display portion and a bottom display portion, and
ii. said computing device support arm is configured to support the computing device such that,
said display is positioned in front of said frame, spaced apart from, and adjacent one of, said first and second frame openings, and
said bottom portion of said display is positioned above said centerline of said one of said first and said second frame openings so as not to substantially obstruct the neutral line of sight of the wearer.

28. The eyewear of claim 27, wherein said computing device support arm is configured to support the computing device such that when said computing device is supported by said computing device support arm:
a. said display bottom portion is positioned substantially above a first plane that contains said neutral line of sight of the wearer when said wearer is wearing said eyewear, and
b. said upper portion of said display is at, or below, a second plane that contains an upper line of sight of said wearer when the wearer is wearing said eyewear.

29. The eyewear of claim 27, wherein a first angle between said first plane and a third plane that contains a first line of sight that is substantially adjacent the lower portion of said display is between about 10 degrees and about 50 degrees.

30. The eyewear of claim 29, wherein said first angle is about 15 degrees.

31. The eyewear of claim 29, wherein a second angle between said first plane and said second plane is between about 15 degrees and about 85 degrees.

32. The eyewear of claim 31, wherein said second angle is about 25 degrees.

33. The eyewear of claim 32, wherein said computing device support arm is configured to support the computing device such that said frame is disposed in a position that does not substantially interfere with a line of sight of said wearer to an upper portion of said display.

34. The eyewear of claim 27, further comprising
a. a first frame support comprising an adjustable arm having a first end coupled to the frame and a second end coupled to a first nose pad; and
b. a second frame support comprising an adjustable arm having a first end coupled to the frame and a second end coupled to second nose pad,
wherein said first and second nose pads are configured to cooperate to maintain said frame in a substantially fixed position relative to said wearer's face.

35. The eyewear of claim 34, wherein:
a. said first adjustable arm is configured to enable said wearer to adjust a position of said first nose pad relative to said frame; and
b. said second adjustable arm is configured to enable the wearer to adjust a position of said second nose pad relative to said frame.
